(19) United States
(12) Patent Application Publication
(10) Pub. No.: US 2013/0000460 A1
(43) Pub. Date: Jan. 3, 2013

(54) MOUNTING SYSTEM FOR ACOUSTIC MUSICAL INSTRUMENTS

(76) Inventor: Darrell Johnston, Harbor City, CA (US)

(21) Appl. No.: 13/536,991

(22) Filed: Jun. 28, 2012

Related U.S. Application Data
(60) Provisional application No. 61/502,211, filed on Jun. 28, 2011.

(51) Int. Cl. G10D 13/02

(52) U.S. Cl. 84/421

(57) ABSTRACT

Described is a mounting system for acoustic musical instruments. The mounting system includes a central hub with three suspension arms extending thereform. Each extension arm having a proximal end connected with the central hub and a distal end having a gripper arm assembly. A lower support cushion and a gripper pad are connected with each gripper arm assembly, both of which are formed of neoprene. Thus, a user can position a drum hoop on the lower support cushions and use the gripper pads to secure the drum therebetween. In doing so, the mounting system provides a secure, rigid grip on the instrument for performance, while ensuring the instrument is undamaged and fits all types of counter hoops in popular use. Additionally, due to the neoprene, the mounting system allows the acoustic instrument to resonate (speak) in a more unrestricted manner with respect to the prior art.

### CROSS-REFERENCE TO RELATED APPLICATIONS

This is a Non-Provisional Utility Patent Application of U.S. Provisional Application No. 61/502,211, filed on Jun. 28, 2011, entitled, “Mounting System for Acoustic Musical Instruments.”

### BACKGROUND OF THE INVENTION

(1) Field of Invention

The present invention relates to a mounting system and, more particularly, to a mounting system for acoustic musical instruments.

(2) Description of Related Art

Mounting systems for musical instruments have long been known in the art. For example, a mounting system for a drum includes a basket that is used to hold the drum. A problem with existing baskets is that the contact point between the drum and basket is such that it chokes the drum sound. In other words, existing mounting systems are formed such that they prevent the drum form resonating freely and, thereby, choke the drum.

Thus, a continuing need exists for mounting system for acoustic musical instruments that provides for an “unchoked” optimal drum sound to allow the instrument to resonate freely.

### SUMMARY OF INVENTION

The present invention relates to mounting system for acoustic musical instruments. The mounting system includes a central hub with three telescopic suspension arms extending thereform. Each extension arm having a proximal end connected with the central hub and a distal end having a gripper arm assembly. A lower support cushion and a gripper pad are connected with each gripper arm assembly, both of which are formed of neoprene. Thus, a user can position a drum hoop on the lower support cushions and use the gripper pads to secure the drum therebetween. In doing so, the mounting system provides a secure, rigid grip on the instrument for performance, while ensuring the instrument is undamaged and fits all types of counter hoops in popular use. Additionally, due to the neoprene, the mounting system allows the acoustic instrument to resonate (speak) in a more unrestricted manner with respect to the prior art.

In another aspect, the gripper pads can be formed in any suitable shape, such as cylindrically shaped or as an inverted cone shape with a truncated bottom portion.

In yet another aspect, the lower support cushions can be made to include eccentrically formed holes that pass therethrough. The eccentrically formed holes allow a user to adjust the lower support cushion against the drum hoop to selectively tighten or loosen the contact point therebetween.

Finally, as can be appreciated by one in the art, the present invention also comprises a method for forming and using the invention described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is an illustration of mounting system according to the present invention, depicting the mounting system as attached with a tripod;

FIG. 2 is a top-view illustration of the mounting system according to the present invention;

FIG. 3A is an exploded, side-view illustration of a gripper arm assembly according to the present invention;

FIG. 3B is a side-view illustration of a gripper pad according to the present invention;

FIG. 4 is a bottom-view illustration, depicting the mounting system as attached with a drum; and

FIG. 5 is a cross-sectional, side-view illustration of the gripper arm assembly, depicting the assembly as attached with a drum.

### DETAILED DESCRIPTION

The present invention relates to a mounting system and, more particularly, to a mounting system for acoustic musical instruments. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

(1) Description

The present invention is directed to a mounting system for acoustic musical instruments, such as a drum or any other acoustic musical instrument. As an improvement over the prior art, the mounting system minimizes the area of support contact with the drum as well as the support material that actually engages with (contacts or holds) the drum. In doing so, the mounting system provides for an “unchoked” optimal drum sound that allows the instrument to resonate freely and produce a “voice” in a manner that is superior to traditional methods of support.

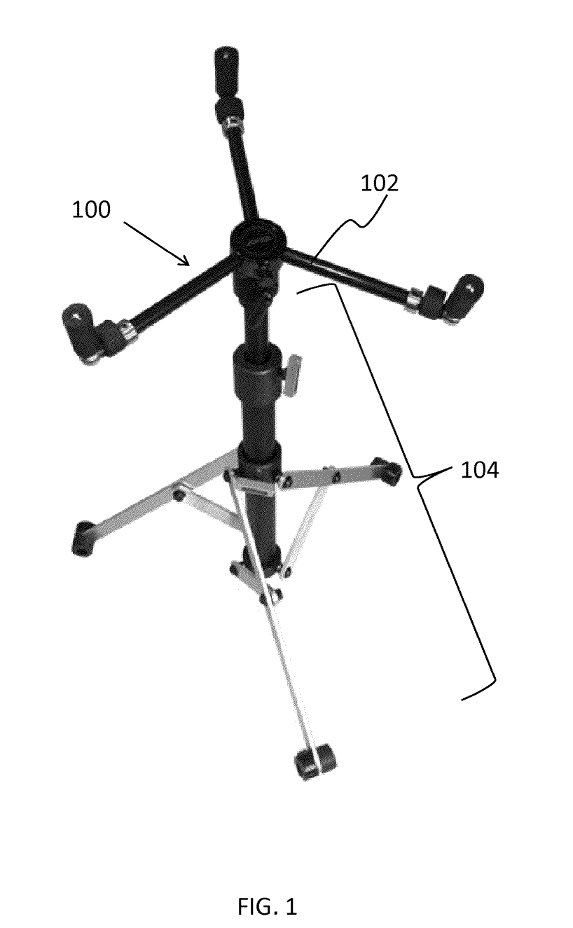

Specifically and as shown in FIG. 1, the mounting system 100 includes a basket with telescoping suspension arms 102. For illustrative purposes, the mounting system 100 is depicted as being attached with a tripod 104. Thus, in operation, a user can attach a musical instrument (e.g., drum) between the suspension arms 102 and use the tripod 104 to adjust the height or elevation of the mounting system 100 (and ultimately the attached drum).

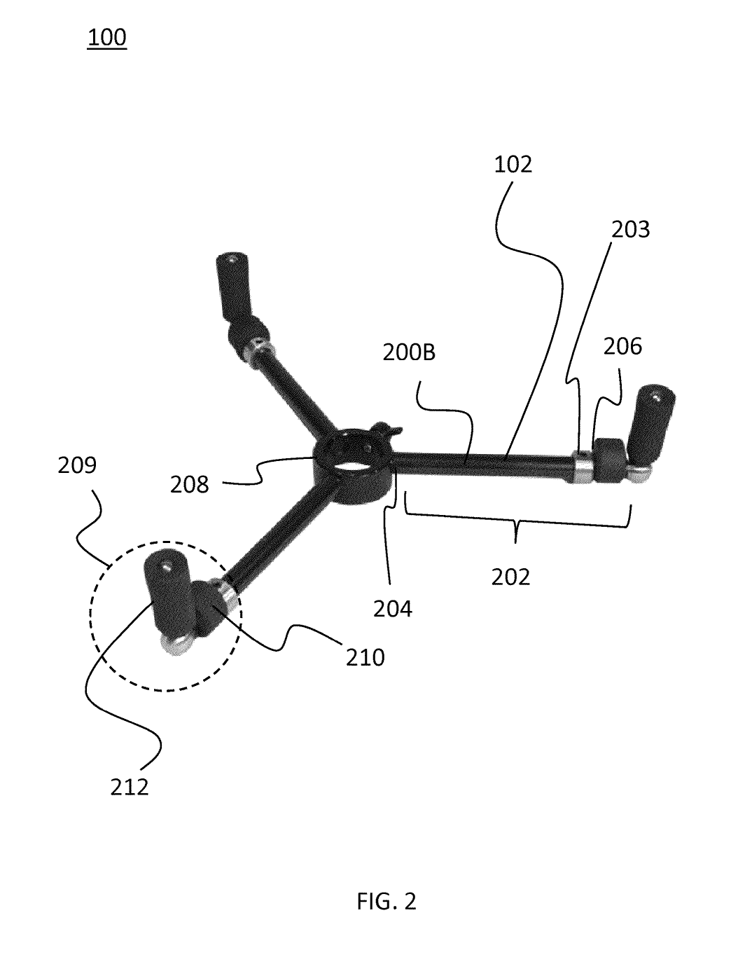

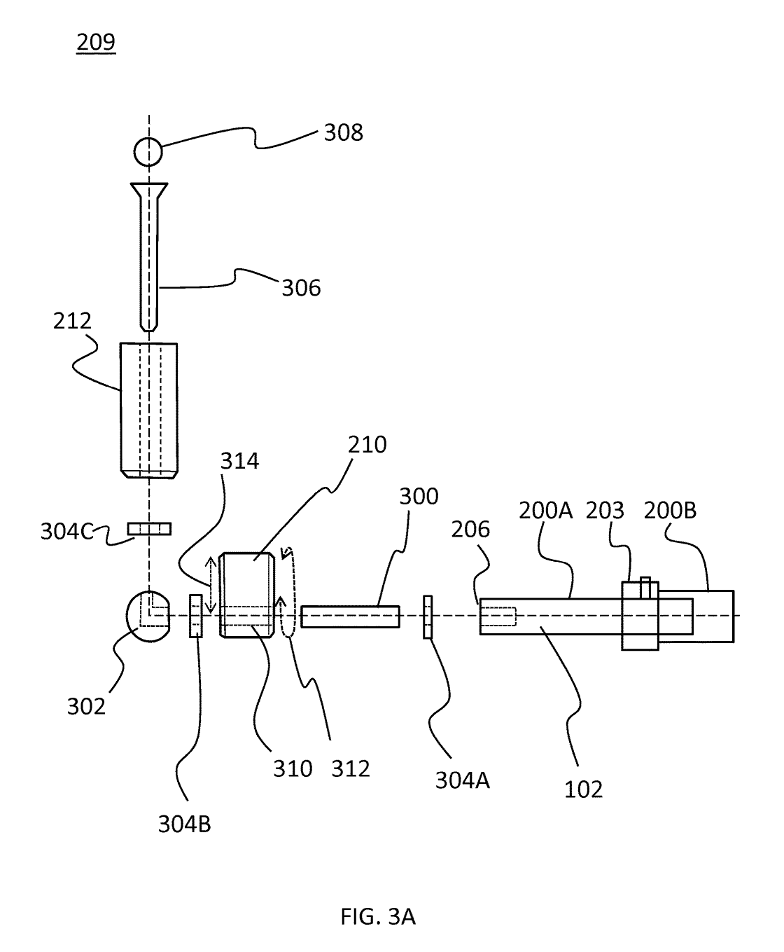

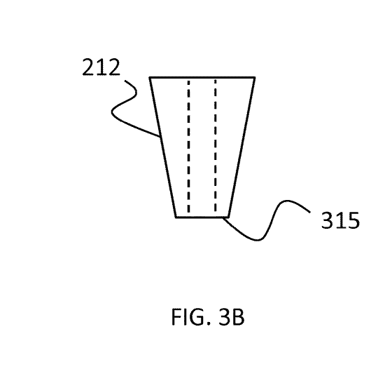

FIG. 2 provides a top-view illustration of the mounting system 100 of the present invention as removed from the tripod. As shown, the mounting system 100 includes a plurality of telescoping suspension arms 102. Each telescoping suspension arm 102 is formed to allow a user to selectively adjust a length 202 of the suspension arm 102. The suspension arms 102 are formed of any suitable mechanism or device that allows for selective length 202 adjustment. As a non-limiting example, each suspension arm 102 includes a first inner steel rod (depicted as element 200A in FIG. 3A) and an outer sleeve steel rod 200B (collectively operating as telescopic joint segments) that allow a user to selectively adjust the length 202 through use of an adjustment collar 203. For example, typically drums range in 8 to 18 inches in diameter. Thus, in this non-limiting example, each suspension arm 102 allows for adjustment of the length from 3 to 12 inches.

Also as shown, each suspension arm 102 includes a proximal end 204 and a distal end 206. The proximal end 204 is attached with a central hub 208 that allows for connection to the tripod (as shown in FIG. 1). The central hub 208 is a quick disconnect hub which allows the acoustic instrument to rotate and tilt (with respect to the tripod) quickly and easily for performance positioning.

Alternatively, each distal end 206 includes a gripper arm assembly 209 having a lower support cushion 210 and a side gripper pad 212. The material of the gripper pads 212 is unique and provides for the “unchoked” optimal sound. Specifically, the gripper pads 212 are formed of any suitably compressive and resilient material, a non-limiting example of which includes neoprene. In selecting the material, it was unexpectedly discovered that neoprene provides for a contact point with the drum that allows the drum to resonate freely and provide a “voice” that is superior to traditional methods of support. In other word, the neoprene allows for resonance to sustain the vibration of the drum as opposed to dampening it (i.e., choking it). Similarly, the lower support cushion 210 is formed of neoprene, which again, was unexpectedly discovered to allow the drum to resonate freely when the drum is supported therein. The use of neoprene is a significant improvement over any mounting systems of the prior art, which used contact points made of a nylon type plastic (e.g., Delrin) that was either machine made or molded. As noted above, a problem with the contact points of the prior art is that they “choked” the sound in the drum, whereas neoprene provides for an “unchoked” sound.

Additional details of the gripper arm assembly 209 are provided in FIG. 3A. FIG. 3A provides an exploded, side-view illustration of the gripper arm assembly 209. As shown, the gripper arm assembly 209 is attached with the distal end 206 of the suspension arm 102. Notably, the gripper arm assembly 209 includes both the gripper pad 212 and lower support cushion 210, each of which is attached with the gripper arm assembly 209 using any suitable mechanism or technique. As a non-limiting example, a set screw 300 (e.g., 0.25 inch−20×1.25 inch) can be threaded into an end of the suspension arm 102 and a brass ball 302 (e.g., ⅝ inch brass ball). Positioned around the set screw 300 is the lower support cushion 210, which is flanked by spacers 304A (e.g., 0.5 inch×0.06 inch thick black nylon spacer (0.25 inch inner diameter)) and 304B (e.g., 0.5 inch×0.13 inch thick black nylon spacer (0.25 inch inner diameter)).

Also attached into the brass ball 302 is a top set screw 306 that is threaded into a top portion of the brass ball 302. The top set screw 306 is any suitable connector that allows for connection with the brass ball 302, a non-limiting example of which includes a #10-32 flat head cap screw that is 1.75 inches in length. Positioned around the top set screw 306 are the gripper pad 212 and another spacer 304C (e.g., 0.5 inch×0.13 inch thick black nylon spacer (#10 inner diameter)). Attached with the top set screw 306 is a steel ball 308, such as a ⅜ inch steel ball. The steel ball 308 can be press fit into the neoprene gripper pad 212 to provide a smooth, non-abrasive top. Alternatively, the top set screw 306 could be a ball head screw.

It should be noted that the gripper pad 212 and lower support cushion 210 can be formed in any suitable size and shape to allow for sufficiently gripping the side of a drum hoop (e.g., counter hoop). As a non-limiting example and as depicted in FIG. 3A, the gripper pads 212 are cylindrically shaped. Alternatively and as depicted in FIG. 3B, the gripper pad 212 can be formed with a flare to form an inverted cone shape. A bottom portion 315 of the gripper pad 212 can be truncated such that it does not come to a point (as opposed to a real inverted cone shape). In this aspect, due to the flare, a connected drum becomes increasingly compressed against the gripper pad 212 as it rises from the mounting system and, as such, is less likely to become loose.

With respect to the size and referring again to FIG. 3A, the gripper pad 212 is black neoprene that is 1.7 inches tall, with an inner diameter of 0.25 inches and an outer diameter of 0.75 inches. Alternatively, the lower support cushion 210 can be 1.0 inch thick and 0.6 inches long. It should be noted that the specific dimensions provided throughout this specification are non-limiting examples as the invention is not intended to be limited to such dimensions and can be employed using any suitable dimensions.

It should also be noted that the hole 310 passing through the lower support cushion 210 can be formed such that it is centrally located or, alternatively, eccentrically located (as illustrated). Thus, in this aspect, the lower support cushion 210 is an eccentric adjustment support cushion which allows for precise positioning of a variety of acoustic instruments. In other words, the lower support cushion 210 can be rotated 312 around the set screw 300 to adjust the height 313 of the lower support cushion 210, thereby allowing for adjustment to provide for a secure and rigid connection point with a drum.

Also depicted are the inner steel rod 200A, adjustment collar 203, and outer sleeve steel rod 200B, that collectively allow a user to selectively adjust the length through use of the adjustment collar 203. In other words, through the adjustment collar 203 and telescoping suspension arms 102, a user can bring the arms 102 into a snug fit with the drum.

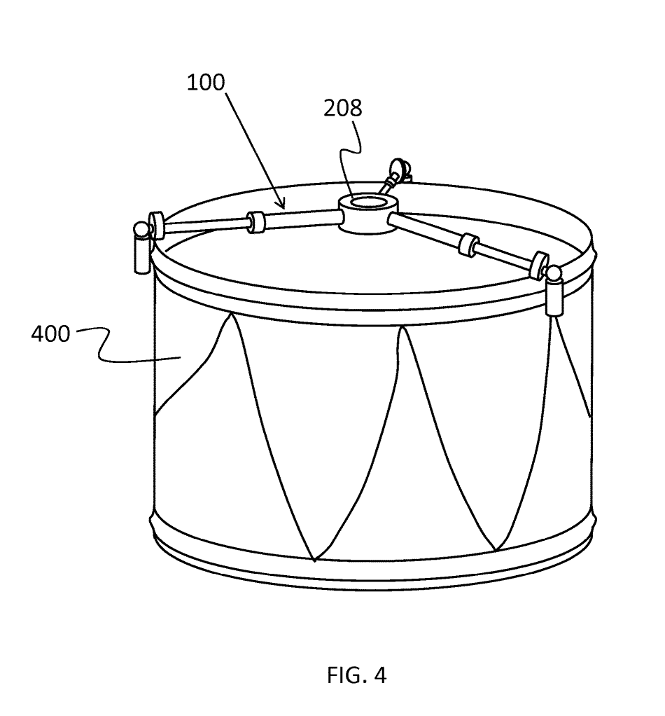

As shown in FIG. 4, the mounting system 100 forms a basket that can be attached to the underside of an acoustic instrument (such as a drum 400), thereby allowing for a low profile and streamlined set up. As noted above, the mounting system 100 has a quick disconnect central hub 208 which allows the acoustic instrument to rotate and tilt quickly and easily for performance positioning. The quick disconnect to the central hub 208 atop a ball swivel post (of the tripod as illustrated in FIG. 1) is independent of the positioning aspect (as described with respect to FIGS. 2 and 3A) which allows for the breakdown and set-up where the instrument's precise position is maintained. A ball grip swivel atop the tripod is a spherical center post which is supported and contained by smaller spherical contacts (grippers) positioned opposite the tightening screw and equidistant above/below the ball grip swivel spherical equator. This containment cup has a slot/opening to increase the range of free movement of the ball post.

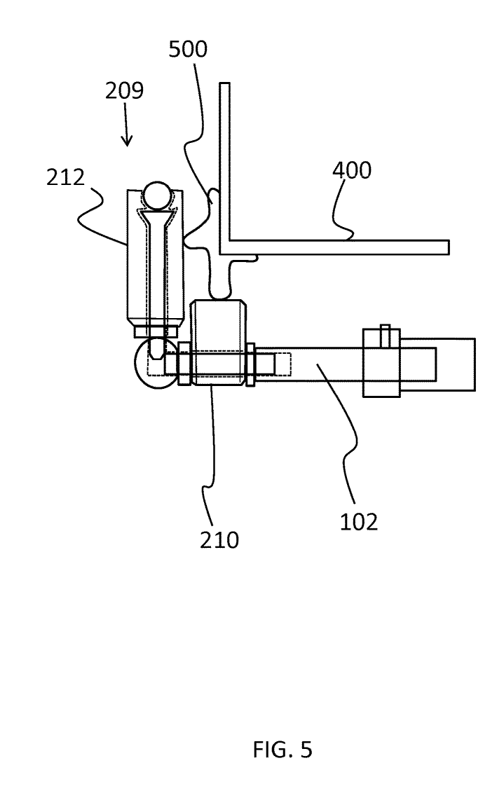

As noted above, the mounting system 100 provides for neoprene-based supports that act as support members and contact points with the actual acoustic instrument. In other words and as depicted in FIG. 5, the only point of contact that the mounting system has with the acoustic instrument is at the gripper pad 212 and lower support cushion 210. Specifically, FIG. 5 is an illustration of the gripper arm assembly 209, showing the assembly 209 in contact with a drum 400. More specifically, shown is a cross-section of a drum 400 and its drum hoop 500. As commonly understood by one skilled in the art, the drum hoop 500 is a “hoop” or “rim” that may be made by of metal, wood, or other material and is used to hold a drumhead against a drum shell, either with bolts through metal “claws” attached directly to a hoop, or bolts through holes in a flanged rim.

As applied to the present case, the drum hoop 500 is held in place by positioning it between the suspension arms 102, with the gripper pads 212 holding the drum hoop 500. The drum hoop 500 is also supported by the lower support cushion 210, which can be rotated for adjustment (due to the eccentric hole) to bring it snugly against the drum hoop 500. Thus, the only contact point with the drum 400 is via the gripper pads 212 and lower support cushion 210, both of which are made of neoprene.

In summary, the mounting system 100 provides a secure, rigid grip on the instrument for performance, while ensuring the instrument is undamaged and fits all types of counter hoops in popular use. The mounting system 100 additionally allows the acoustic instrument to resonate (speak) in a more unrestricted manner. Current devices can dampen the instrument, thereby limiting (choking) the sound.

Acoustic (sound) waves propagate freely from the instrument into the air, but are not conducted into the mounting hardware. The configuration of the present invention allows resonance within the instrument but prevents the transmission of resonant wave energy through itself. Just as a mirror reflects rather than absorbs incident light energy, this system provides an acoustic reflectivity which sustains the sound wave energy

What is claimed is:

1. A mounting system for acoustic musical instruments, comprising:
a central hub, with a plurality of suspension arms extending thereform, each extension arm having a proximal end connected with the central hub and a distal end having a gripper arm assembly; and
a gripper pad connected with each gripper arm assembly, whereby a user can position a drum hoop and attached drum between the gripper pads of each gripper arm assembly to hold the drum therebetween.

2. The mounting system as set forth in claim 1, wherein each gripper arm assembly further comprises a lower support cushion attached with a distal end of the suspension arm.

3. The mounting system as set forth in claim 2, wherein each gripper pad is formed of neoprene.

4. The mounting system as set forth in claim 3, wherein each lower support cushion is formed of neoprene.

5. The mounting system as set forth in claim 4, wherein each lower support cushion includes an eccentrically formed hole passing therethrough.

6. The mounting system as set forth in claim 5, wherein each extension arm is a telescoping suspension arm, formed to allow a user to selectively adjust a length of the suspension arm.

7. The mounting system as set forth in claim 6, wherein the gripper pad is formed with a flare in an inverted cone shape with a truncated bottom portion.

8. The mounting system as set forth in claim 1, wherein each gripper arm assembly further comprises a lower support cushion attached with a distal end of the suspension arm.

9. The mounting system as set forth in claim 8, wherein each lower support cushion is formed of neoprene.

10. The mounting system as set forth in claim 8, wherein each lower support cushion includes an eccentrically formed hole passing therethrough.

11. The mounting system as set forth in claim 1, wherein each gripper pad is formed of neoprene.

12. The mounting system as set forth in claim 1, wherein each extension arm is a telescoping suspension arm, formed to allow a user to selectively adjust a length of the suspension arm.

13. The mounting system as set forth in claim 1, wherein the gripper pad is formed with a flare in an inverted cone shape with a truncated bottom portion.
